(19) United States
(12) Patent Application Publication
(10) Pub. No.: US 2021/0363812 A1
(43) Pub. Date: Nov. 25, 2021

(54) Aerogel Mosaic-based Window System

(71) Applicants: Zineb Hajjaj, Schenectady, NY (US); Ann M. Anderson, Scotia, NY (US); Mary K. Mahony, Schenectady, NY (US)

(72) Inventors: Zineb Hajjaj, Schenectady, NY (US); Ann M. Anderson, Scotia, NY (US); Mary K. Mahony, Schenectady, NY (US)

(73) Assignee: Union College, Schenectady, NY (US)

(21) Appl. No.: 17/324,514

(22) Filed: May 19, 2021

Related U.S. Application Data
(60) Provisional application No. 63/027,589, filed on May 20, 2020.

(51) Int. Cl. E06B 3/67; E06B 3/677

(52) U.S. Cl. CPC E06B 3/6715; E06B 3/6775; E06B 3/6707

(57) ABSTRACT

A mosaic-style design aerogel window system having two panes of translucent material assembled parallel to each other in a frame to form a window panel is disclosed. A variety of aerogel monoliths of various colors are assembled in a layer between the two panes of translucent material such that edges of adjacent aerogel monoliths mate with each other. Aerogel monoliths are prepared from a plurality of cut or molded shapes of aerogel monoliths, each having at least one dimension of ¼ inch or greater. At least some of the plurality of aerogel monoliths have dyes or salts incorporated into a precursor recipe to impart color to the colored aerogel monoliths.

### CROSS REFERENCE

This application claims the benefit of the filing date of U.S. Provisional Patent Application No. 63/027,589, filed May 20, 2020, which is hereby incorporated by reference in its entirety.

### FIELD

The present disclosure relates an aerogel mosaic-based window system and method of fabrication.

### BACKGROUND

Because aerogels are translucent, they can be used to make thermally and acoustically insulating windows. However, due to the nature of the material, they scatter light and are not fully transparent which limits their use to daylighting applications.

Commercial aerogel-based windows use aerogel granules (small pieces) in-between the glass panes. These are produced by companies such as Kalwall (https://www.kalwall.com/), and Advanced Glazings (https://www.advancedglazings.com/). However, these windows are opaque which limits their ability to provide natural lighting and they are not durable due to sagging of the granules in the window frame over time.

There are reports in the literature of large monolithic (single piece) aerogel-based windows which sandwich the monolithic aerogel between glass panes (see for example: Jensen et al., 2004, Development of windows based on highly insulating aerogel glazings. Journal of Non-Crystalline Solids, 350, 351-357). However, there are no commercial products made from aerogel monoliths because it is difficult to manufacture large monoliths and, while more translucent than granules, surface imperfections and light scattering detract from the overall look of the window.

Alternatively, aerogel-based windows can be made using smaller aerogel monoliths that are easier to make by tiling the monoliths between two pieces of glass. Anderson and Carroll have done this with 3.5″×3.5″×0.5″ (Bhuiya et al., 2016, Preparation of monolithic silica aerogel for fenestration applications: Scaling up, reducing cycle time, and improving performance, Industrial & Engineering Chemistry Research, 55, 6971-6981) and with 4″×4″×0.6″ aerogel monoliths (Zinzi et al., 2018, Acoustic measurements on monolithic aerogel samples and application of the selected solutions to standard window systems, Applied Acoustics, 142, 123-131) tiled between two pieces of glass.

While thermally and acoustically insulating, and quite translucent (letting the light in), the prototypes are unattractive due to seam lines, surface imperfections, and light scattering.

### SUMMARY

In accordance with one aspect of the present invention, there is provided a mosaic-style design aerogel window system, including two panes of translucent material assembled parallel to each other in a frame to form a window panel; and a plurality of cut or molded shapes of aerogel monoliths at least some of which are of various colors, each aerogel monolith having at least one dimension of ¼ inch or greater and optionally having dyes or salts incorporated into a precursor recipe to make the colored aerogel monolith, wherein the plurality of aerogel monoliths are assembled in a layer between the two panes of translucent material such that edges of adjacent aerogel monoliths mate with each other, resulting in a thermally and acoustically insulating and translucent mosaic-style design aerogel window system.

These and other aspects of the present disclosure will become apparent upon a review of the following detailed description and the claims appended thereto.

### BRIEF DESCRIPTION OF THE DRAWINGS

FIG. 1 is an exploded view of a finished assembly of an embodiment of a mosaic-style design aerogel window system in accordance with the present invention;

FIG. 2A is an exploded view of a window system, illustrating a procedure for compressing monoliths during assembly and FIG. 2B is a front view of the assembled system of FIG. 2A representing an embodiment of a mosaic-style design aerogel window system in accordance with the present invention;

FIG. 3 is a photograph of a series aerogels of selected colors wherein dyes or salts are incorporated into the aerogel precursor recipe;

FIGS. 4A, 4B and 4C are photos of a series of single colored monoliths laser cut into multiple pieces;

FIGS. 5A and 5B are photos of a series of pieces of the laser cut monoliths of FIGS. 4A-C assembled into multi-colored aesthetic mosaic-style designs; and

FIG. 6 is a photograph of a variety of surface etched aerogel monoliths.

### DETAILED DESCRIPTION

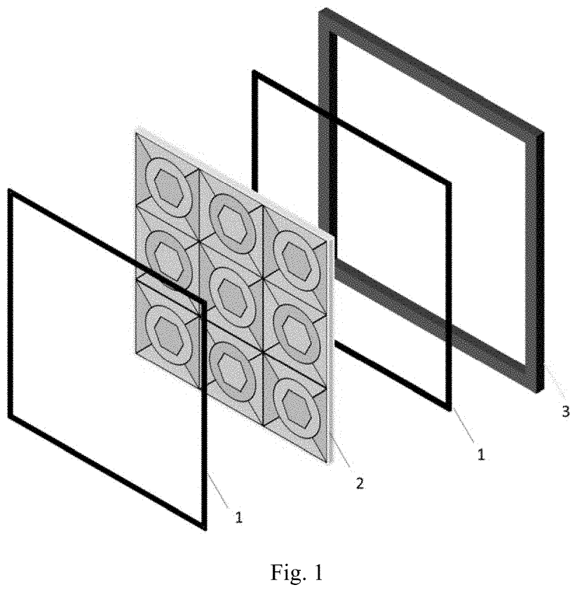

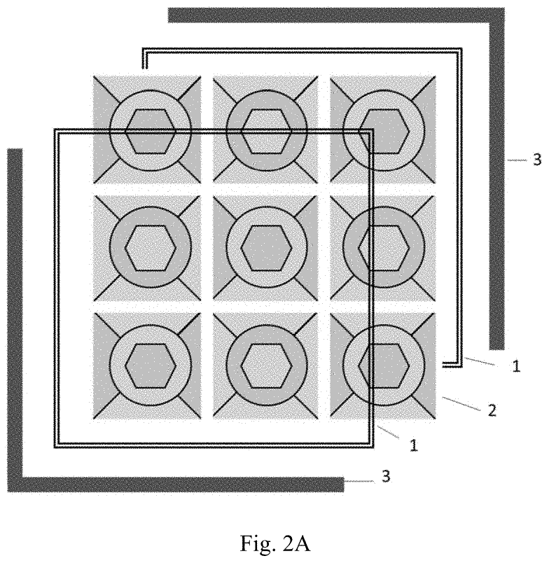

This disclosure relates to a mosaic-style design aerogel window system shown in FIG. 1 having two panes 1 of translucent material assembled parallel to each other in a frame 3 to form a window panel. A plurality of cut or molded shapes of aerogel monoliths 2 of various colors or colorless, each aerogel monolith having at least one dimension of ¼ inch or greater assembled in a layer between the two panes of translucent material such that edges of adjacent aerogel monoliths mate with each other as shown in FIGS. 1, 2A and 2B. This results in a thermally and acoustically insulating and translucent mosaic-style design aerogel window system. In an embodiment, dyes or salts are incorporated into a precursor recipe to impart color to some of the colored aerogel monoliths.

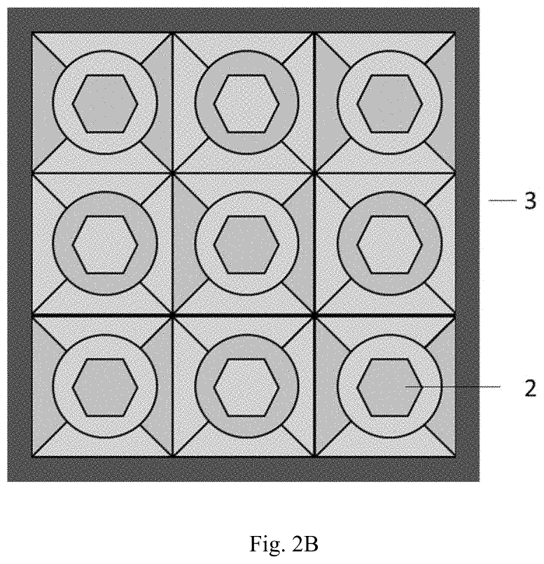

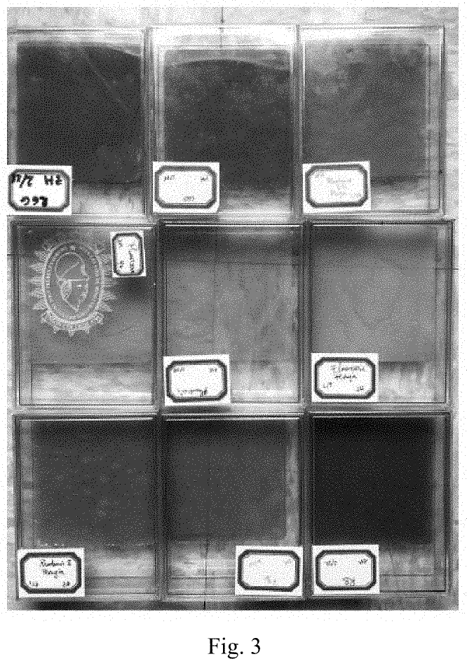

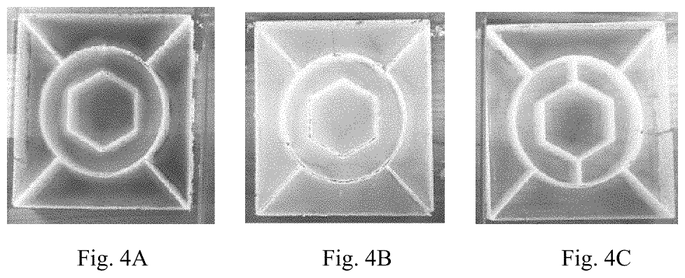

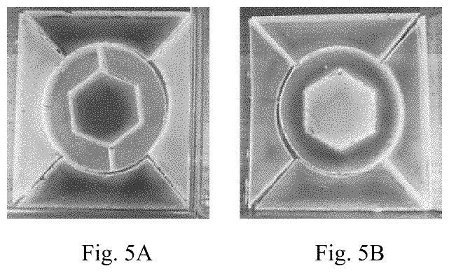

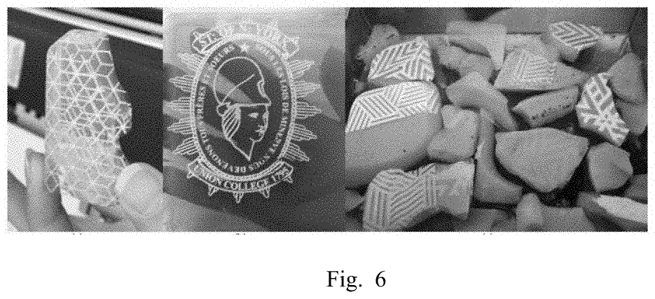

An embodiment includes fabrication of an aerogel mosaic-based window system made from a variety of aerogel monoliths assembled into aesthetically pleasing patterns. Monolithic aerogels can be prepared by known methods, such as the patented Union College rapid supercritical extraction method. Dyes or salts can be incorporated into the aerogel precursor recipe to make aerogels of selected colors, such as red, blue, or green and all the hues therein (see for example FIG. 3). A laser cutter can be used to cut shapes from the aerogel monoliths (FIG. 4A-C). These shapes are reassembled, mixing shapes from different colored and or colorless monoliths, to form mosaics (FIG. 5A-B). The aerogel monoliths can also be etched with interesting patterns (FIG. 6). These mosaics can be placed between two panes of glass and assembled to form large window panels.

This system has applications in fenestration and architecture. The aerogel mosaics are thermally and acoustically insulating and they are translucent. They could be used for daylighting applications where the goal is to reduce energy loss while bringing in natural light.

Numerous researchers have attempted to improve the optical characteristics of aerogels, but none have succeeded. The present method solves the problems associated with previous aerogel-based windows. The smaller aerogel mosaics (1) are easier to fabricate than larger monoliths; (2) can be used to make large aerogel-based windows by tiling smaller pieces and (3) the dyed mosaic pattern solves the problem of surface defects and light scattering through the use of dyes to color the aerogels and etching to result in a mosaic-style window in which the design is aesthetically pleasing and in which surface imperfections in the aerogel monoliths are features that render each window unique.

The present aerogel window is one in which aerogel material is sandwiched between two panes of suitable translucent material, such as glass, Plexiglas or polycarbonate. An aerogel mosaic-based window system includes two panes assembled parallel to each other to form a large window panel. The size of the window panel can be any size desired and includes typical commercial and residential window sizes, for example the window panel can be larger than 4″×4″.

The aerogel monoliths sandwiched between the two panes include a plurality of cut or molded shapes of dyed aerogel monoliths having at least one dimension of ¼ inch or greater. Typical sizes include a range from 1″×1″×0.125″ to 5″×5″×1″. Each colored aerogel monolith has dyes or salts incorporated into a precursor recipe to make the aerogel monoliths of various colors. Colorless aerogel monoliths can also be mixed in with the colored aerogel monoliths to form a mosaic. The plurality of aerogel monoliths is disposed in a layer between the two panes of glass to form a thermally and acoustically insulating and translucent window system.

One or more of the plurality of aerogel monoliths can be surface etched. Anderson and Carroll have demonstrated the use of a laser etching systems to engrave text and images onto the surface of silica aerogel monolith without resulting in damage to the bulk aerogel structure. (Michalou(di)s et al. 2018, Facile Method for Surface Etching of Silica Aerogel Monoliths, Journal of Sol-gel Science and Technology, 87, 22-26) (Stanec et al. 2020, Analysis and Characterization of Etched Silica Aerogels, Journal of Sol-gel Science and Technology, 94 406-415) (Stanec et al. 2021, Aesthetically Enhanced Silica Aerogel via Incorporation of Laser Etching and Dyes, Journal of Visualized Experiments, doi: 10.3791/61986) Etched portions appear white in color because light is scattered from the portions of the surface from which material was ablated and at which localized melting occurred during the etching process. The extent of surface etching and, therefore, the intensity of scattered light and apparent white color is controlled by varying the laser power and speed of etching. Etching of monoliths imparts distinctive optical and artistic features to both the individual aerogel pieces and the overall mosaic pattern. (See FIG. 6)

The resulting mosaic-style window design is aesthetically pleasing and any surface imperfections of the plurality of aerogel monoliths render each window unique. The colors and shapes are assembled into an aesthetically pleasing arrangement that will be interpreted by a viewer as a stained-glass window type of design. Typical stained-glass windows are made of individual pieces of colored glass assembled in a single layer with seams between components (generally made of metal, which results in significant thermal loss) and surface imperfections; these are viewed as part of, rather than a detriment to, the design. Seams created by abutting aerogel pieces in the aerogel mosaic-based window system are less visually intrusive than those in traditional stained-glass windows. The edges of as-prepared silica aerogel monoliths have sufficient surface roughness to result in firm mating of individual adjacent pieces under compression. (see FIG. 2A) When laser cutting is employed, the increased roughness results in enhanced contact between pieces and yields visible white seams due to scattering of light from the laser-cut surface. These seams give a stained-glass window aesthetic to the mosaic pattern without the thermal loss experienced at junctions between glass pieces in conventional stained-glass windows. (see FIG. 2B).

In an embodiment, the window system is composed of a single layer of a plurality of aerogel monoliths. Preferably, the layer of the plurality of aerogel monoliths consists solely of monolithic aerogels. Suitable layer thickness of multiple individual monoliths includes from ¼″ to 1″ in thickness. In an embodiment, multiple layers of the plurality of aerogel monoliths can be used when additional scattering of light is desired.

In accordance with the present window system, visible light is transmitted through more than 90% of the surface area of the window panel. Each dyed aerogel will behave differently depending on the color and hue imparted by the dye or salt and the opacity. Visible light will pass through most of the surface of the window system, at wavelengths not absorbed by the colored dye or salt, thereby resulting in a colored pattern. The only visually opaque regions will be the seams between individual pieces and etched designs, which scatter visible light. Depending on the design, those features will occupy 1 to 10% of the surface area of the window system.

In an embodiment, the window system exhibits a thermal insulation value of R≥5 hr ft²° F./BTU per half inch of aerogel, without evacuation of air from the system. Monolithic silica aerogels are highly insulating due to the tortuosity of the solid matrix. It is therefore possible to achieve high R values without the need to evacuate air from the window system. Evacuation of air from an aerogel mosaic window system would result in even higher R values as compared to an aerogel mosaic window system without evacuation of air from the system.

In an embodiment, the window system exhibits a thermal insulation value of R≥5 hr ft²° F./BTU per half inch of aerogel, without use of an inert gas layer. Inert gases are employed in some high-performance double- or triple-pane windows to improve thermal insulation. Argon, for example, is denser than air. Monolithic silica aerogels are highly insulating due to the tortuosity of the solid matrix. It is therefore possible to achieve high R values without the need to replace air in the pores of the monolith with an inert gas.

In an embodiment, the window system employs a compression fitting technique to assemble aerogel monoliths into a mosaic pattern with minimal thermal bridging during fabrication. The window system is assembled without the use of non-aerogel spacers between the aerogel monoliths. The individual aerogel pieces are placed on the bottom pane of the two panes and held in place by an outer frame that covers at least half of the perimeter. When the aerogel mosaic pattern is complete the other portion of the outer frame is used to press the mosaic pieces together and thereby forming a tight fit. The upper pane is then placed over the assembly to form a window. (See FIG. 2)

Although various embodiments have been depicted and described in detail herein, it will be apparent to those skilled in the relevant art that various modifications, additions, substitutions, and the like can be made without departing from the spirit of the disclosure and these are therefore considered to be within the scope of the disclosure as defined in the claims which follow.

What is claimed:

1. A mosaic-style design aerogel window system, comprising:
two panes of translucent material assembled parallel to each other in a frame to form a window panel; and
a plurality of cut or molded shapes of aerogel monoliths at least some of which are of various colors, each aerogel monolith of the plurality having at least one dimension of ¼ inch or greater, wherein the plurality of aerogel monoliths are assembled in a layer between the two panes of translucent material such that edges of adjacent aerogel monoliths mate with each other, resulting in a thermally and acoustically insulating and translucent mosaic-style design aerogel window system.

2. The window system of claim 1, wherein the layer is a single layer or multiple layers of the plurality of aerogel monoliths.

3. The window system of claim 1, wherein dyes or salts are incorporated into a precursor recipe to make the colored aerogel monolith.

4. The window system of claim 1, wherein the layer of the plurality of aerogel monoliths consists of the plurality of monolithic aerogels.

5. The window system of claim 1, wherein visible light is transmitted through more than 90% of the surface area of the window panel.

6. The window system of claim 1, wherein the window panel exhibits a thermal insulation value of R≥5 hr ft²° F./BTU per half inch of aerogel monolith, without evacuation of air from the system.

7. The window system of claim 1, wherein the window panel exhibits a thermal insulation value of R≥5 hr ft²° F./BTU per half inch of aerogel monolith, by evacuation without use of an inert gas layer.

8. The window system of claim 1, wherein the layer is assembled with a compression fitting of the plurality of aerogel monoliths into a mosaic pattern with minimal thermal bridging during fabrication.

9. The window system of claim 1, wherein the system is assembled without the use of non-aerogel spacers between the aerogel monoliths.

10. The window system of claim 1, wherein the translucent material is glass, Plexiglas or polycarbonate.

11. The window system of claim 1, wherein at least one of the plurality of cut or molded shapes of aerogel monoliths is surface etched.
